(19) United States
(12) Patent Application Publication
(10) Pub. No.: US 2026/0208074 A1
(43) Pub. Date: Jul. 23, 2026

(54) TRANSMISSION VALVE BODY HAVING A SPACER PLATE FITTED WITH A RIGID FILTER PLATE

(71) Applicant: GM GLOBAL TECHNOLOGY OPERATIONS LLC, Detroit, MI (US)

(72) Inventors: Abhay Ranchoddas BHANDARI, Troy, MI (US); Mark R. CLAYWELL, Birmingham, MI (US); Kannan Murugesan P, Namakkal (IN); Jed PANGILINAN, Farmington Hills, MI (US)

(21) Appl. No.: 19/034,925

(22) Filed: Jan. 23, 2025

(51) Int. Cl. B01D 29/01; B01D 35/02

(52) U.S. Cl. CPC B01D 29/01; B01D 35/02

(57) ABSTRACT

A spacer plate for a drive unit valve body includes a first layer, a second layer bonded to the first layer, and a plurality of openings formed in the first layer and the second layer. At least one of the plurality of openings includes a rigid filter plate including a material web including a plurality of filter openings, and a peripheral edge surrounding the material web, the peripheral edge is devoid of filter openings and arranged between the first layer and the second layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of vehicles and, more particularly, to a transmission valve body including a spacer plate fitted with a rigid filter plate for a vehicle transmission.

Automatic transmissions include an input shaft, an output shaft, and one or more gears that are either changed incrementally or continuously to control a ratio of input shaft speed to output shaft speed. The output shaft is connected to wheels which power the vehicle. Automatic transmissions rely on a flow of hydraulic fluid through various valves to control gear position. The valves are incorporated into a valve body that includes multiple fluid pathways. The hydraulic fluid flows along the multiple fluid pathways to and from select ones of the valves which operate to set the selected gear ratio.

Transmission valve bodies include multiple valve plates that include various orifices that direct the fluid into select ones of the multiple fluid pathways based on a position of one or more of the valves. Spacer plates are placed between the valve plates to act as a gasket. The spacer plates include openings that align with the orifices in the valve plates. A filter is placed in select ones of the openings. The filter takes the form of a wire mesh screen that is positioned to trap debris that may be entrained in the fluid. The debris may enter into a valve and degrade valve performance.

### SUMMARY

A spacer plate for a drive unit valve body, in accordance with the present disclosure, includes a first layer, a second layer bonded to the first layer, and a plurality of openings formed in the first layer and the second layer. At least one of the plurality of openings includes a rigid filter plate including a material web including a plurality of filter openings, and a peripheral edge surrounding the material web, the peripheral edge is devoid of filter openings and arranged between the first layer and the second layer.

In other features, the rigid filter plate includes a thickness of between about 80 μm and about 500 μm.

In other features, each of the plurality of filter openings is between about 100 μm and about 2.0-mm.

In other features, the peripheral edge includes a first side, a second side spaced from the first side, a third side extending between and connecting the first side and the second side, and a fourth side spaced from the third side and extending between and connecting the first side and the second side, the first side and second side having a first length and the third side and the fourth side having a second length that is greater than the first length.

In other features, a reinforcing member extends across the material web.

In other features, a first portion of the plurality of filter openings is spaced from the peripheral edge by less than a diameter of the plurality of filter openings.

In other features, the plurality of filter openings include a first opening density adjacent the peripheral edge and a second opening density at a central portion of the material web, the second opening density being distinct from the first opening density.

In other features, the second opening density is greater than the first opening density.

In other features, each of the plurality of openings includes one of a circular shape and a hexagonal shape.

In other features, the peripheral edge includes one or more fixturing holes that facilitate alignment of the rigid filter plate relative to the at least one of the plurality of openings in the spacer plate.

A drive unit for a vehicle, in accordance with the present disclosure, includes a housing and a valve body fixedly mounted to the housing. The valve body includes a plurality of valve plates and a spacer plate arranged between adjacent ones of the valve plate. The spacer plate includes a first layer, a second layer bonded to the first layer, and a plurality of openings formed in the first layer and the second layer. At least one of the plurality of openings includes a rigid filter plate including a material web having a plurality of filter openings, and a peripheral edge surrounding the material web. The peripheral edge is devoid of filter openings and arranged between the first layer and the second layer.

In other features, the rigid filter plate includes a thickness of between about 80 μm and about 500 μm.

In other features, each of the plurality of filter openings is between about 100 μm and about 2.0-mm.

In other features, the peripheral edge includes a first side, a second side spaced from the first side, a third side extending between and connecting the first side and the second side, and a fourth side spaced from the third side and extending between and connecting the first side and the second side, the first side and second side having a first length and the third side and the fourth side having a second length that is greater than the first length.

In other features, a reinforcing member extends across the material web.

In other features, a first portion of the plurality of filter openings is spaced from the peripheral edge by less than a diameter of the plurality of filter openings.

In other features, the plurality of filter openings include a first opening density adjacent the peripheral edge and a second opening density at a central portion of the material web, the second opening density being distinct from the first opening density.

In other features, the second opening density is greater than the first opening density.

In other features, each of the plurality of openings includes one of a circular shape and a hexagonal shape.

In other features, the peripheral edge includes one or more fixturing holes that facilitate alignment of the rigid filter plate relative at least one of the plurality of openings the spacer plate.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a left side view of a vehicle including a transmission having a valve body provided with spacer plates fitted with plate filters, in accordance with the present disclosure;

FIG. 2 is a partial perspective view of a valve body including spacer plates fitted with rigid filter plates mounted in a drive unit housing, in accordance with the present disclosure;

FIG. 3 is a partially disassembled view of the valve body of FIG. 2, in accordance with the present disclosure;

FIG. 4 is a plan view of the spacer plate fitted with rigid filter plates, in accordance with the present disclosure;

FIG. 5 is a partial perspective view of a rigid filter plate mounted in a spacer plate, in accordance with an aspect of the present disclosure;

FIG. 6 is a partial perspective view of a rigid filter plate mounted in a spacer plate in accordance with another aspect of the present disclosure;

FIG. 7A depicts a spacer plate, in accordance with an aspect of the present disclosure;

FIG. 7B depicts a spacer plate, in accordance with another aspect of the present disclosure;

FIG. 7C depicts a spacer plate, in accordance with yet another aspect of the present disclosure;

FIG. 7D depicts a spacer plate, in accordance with still another aspect of the present disclosure; and

FIG. 7E depicts a spacer plate, in accordance with yet still another aspect of the present disclosure.

In the drawings, reference numbers may be reused to identify similar and/or identical elements.

### DETAILED DESCRIPTION

Hydraulic fluid flows through the valve body under high pressure. The fluid passes through the filter(s) or screen(s) and flows through passages in the valve body. The filters are mounted in a spacer plate across an orifice. The filter is held in place over the orifice along an outer edge. Ebb and flow of the fluid causes the filter to flex in two directions. The repeated flexing of the screen puts a strain on the edges causing material fatigue. Over time, the material fatigue leads to a failure of the filter. The failure typically occurs along the edges of the filter. Preventing filter failure or prolonging filter life will enhance an overall performance and longevity of the transmission.

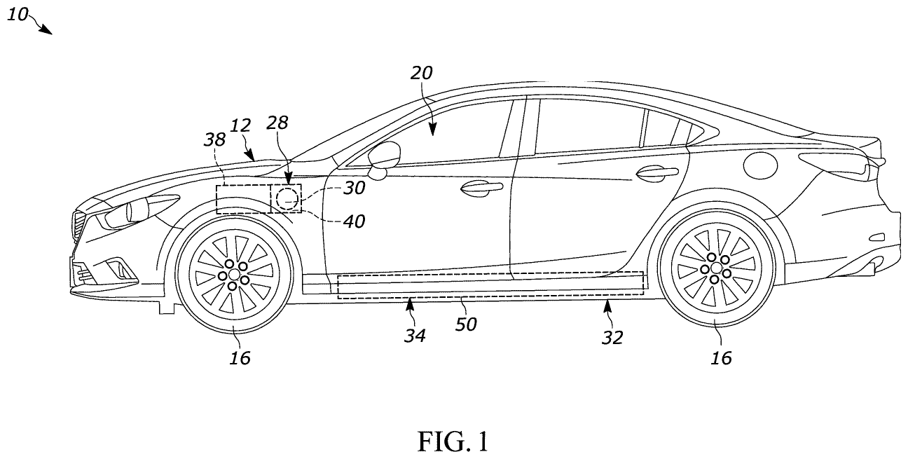

A vehicle, in accordance with a non-limiting example, is indicated generally at 10 in FIG. 1. Vehicle 10 includes a body 12 supported on a plurality of wheels, two of which are indicated at 16. Body 12 defines, in part, a passenger compartment 20. Body 12 includes a charge port cover 28 that houses a charge port 30. Vehicle 10 includes a chassis 32 that supports body 12 and a battery assembly 34. Battery assembly 34 is electrically connected to charge port 30. Chassis 32 is further shown to support a motor 38 that is electrically connected to battery assembly 34. Motor 38 is also mechanically connected with a drive unit 40. Drive unit 40 transfers motive power from motor 38 to one or more of the plurality of wheels 16. The relative position of motor 38 and drive unit 40 may vary depending on vehicle model and features.

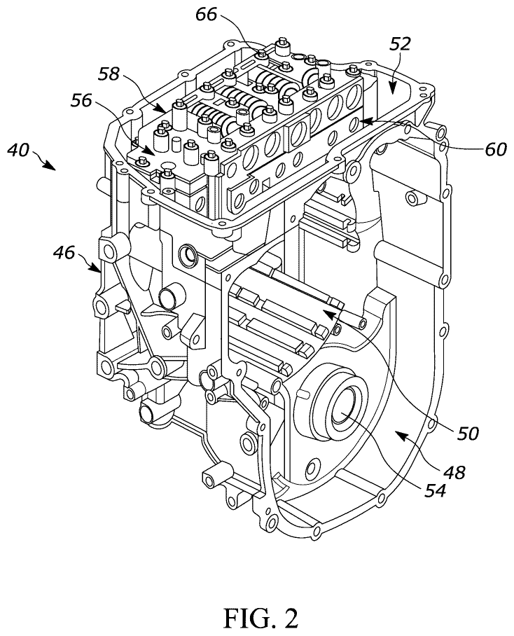

Referring to FIG. 2, drive unit 40 includes a housing 46 having a drive shaft portion 48, a gear train portion 50, and a valve body portion 52. Drive shaft portion 48 includes an opening 54 that accommodates a drive shaft (not shown) that connects drive unit 40 with one or more of the plurality of wheels 16. Gear train portion 50 accommodates one or more gears (also not shown) that establish an output speed/torque for the drive shaft. Valve body portion 52 supports a valve body 56 that controls, based on hydraulic pressure, which gears are operatively connected to the drive shaft.

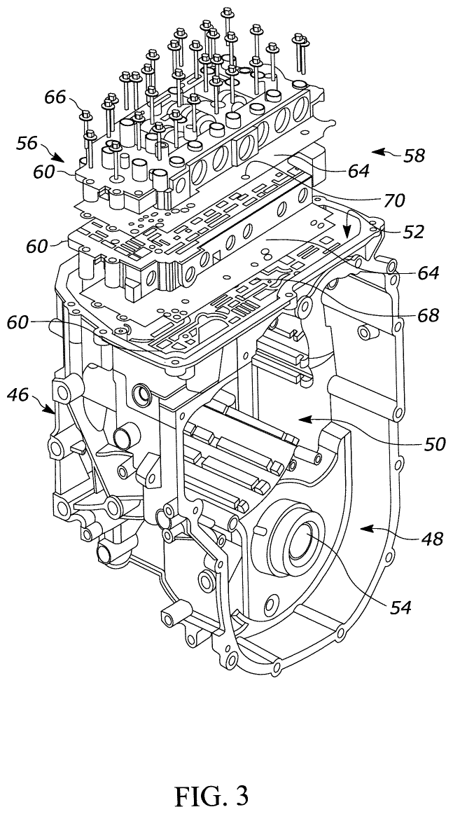

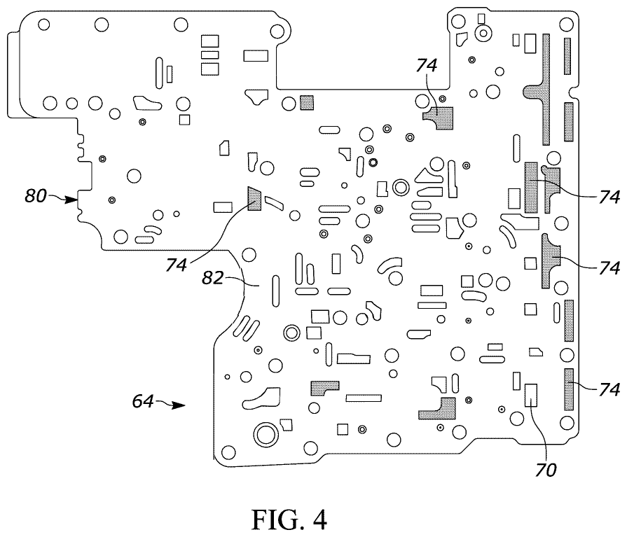

Referring to FIG. 3, valve body 56 is formed of a plurality of stacked plates 58 secured to housing 46 in valve body portion 52 through a plurality of fasteners 66. Stacked plates 58 include valve plates 60 and spacer plates 64. Valve plates 60 include a plurality of passages, one of which is indicated at 68, that guide hydraulic fluid through valve body 56. Spacer plates 64 include a plurality of openings, one of which is indicated at 70, that control fluid flow between passages within a valve plate 60 and between different valve plates 60. As shown in FIG. 4, several of the openings 70 include a rigid filter plate 74 that prevents debris or foreign objects that may be entrained in the hydraulic fluid from reaching certain portions of valve body 56. The term “rigid filter plate” should be understood to describe a monolithic structure having hole or openings formed therein. Rigid filter plate is not mean to encompass wire mesh structures.

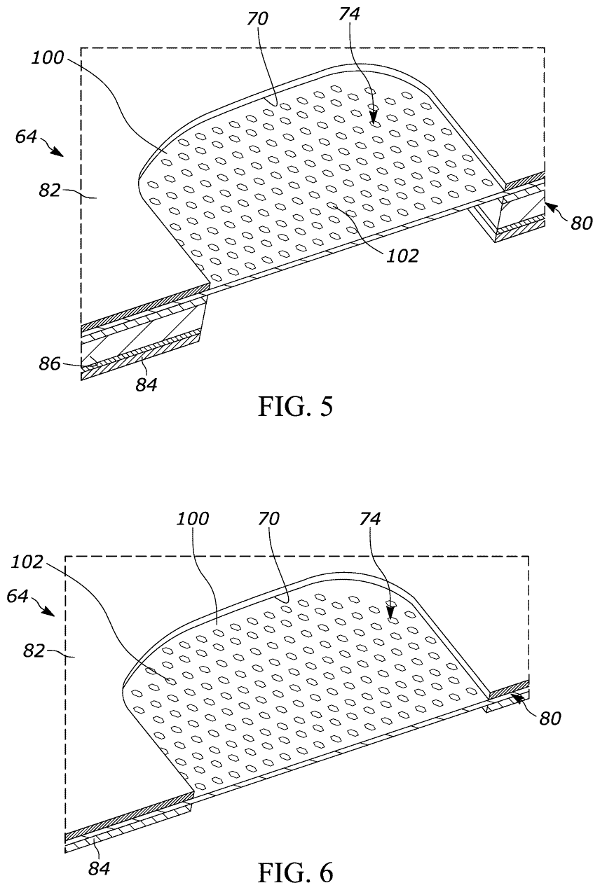

Referring to FIG. 5, spacer plate 64 includes a plurality of layers 80. Layers 80 include a first layer 82 and a second layer 84. First layer 82 defines a first outer layer (not separately labeled) and second layer 84 defines a second outer layer (also not separately labeled). A steel core 86 may be arranged between first layer 82 and second layer 84. Rigid filter plate 74 is arranged between first layer 82 and steel core 86. At this point, it should be understood that number and arrangement of layers 80 may vary, the position of rigid filter plate 74 relative to other layers 80 may vary, and the incorporation of steel core 86 is optional as shown in FIG. 6.

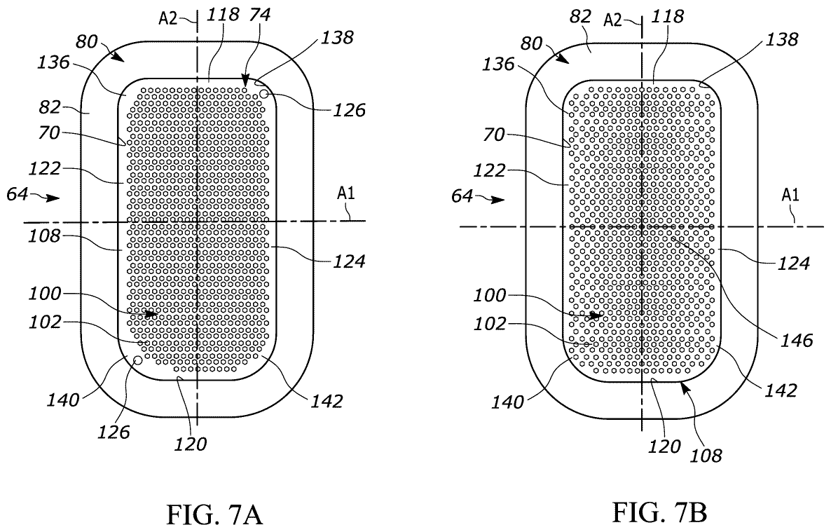

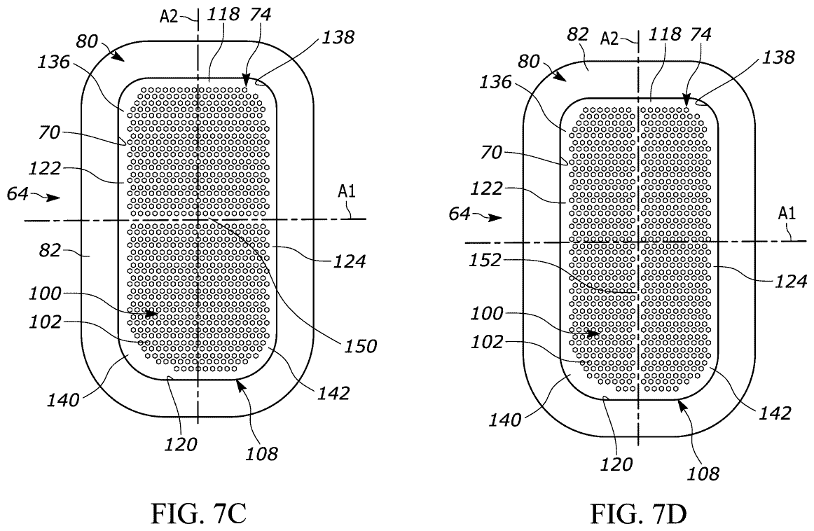

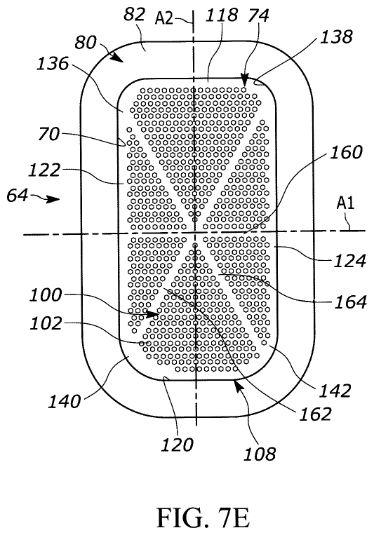

Reference will now follow to FIG. 7A in describing rigid filter plate 74 in accordance with a non-limiting example of the present disclosure. Rigid filter plate 74 includes a material web 100 having formed therein a plurality of filter openings 102. Filter openings 102 may be circular as shown in FIG. 7A or hexagonal as shown in, for example, FIG. 6. The size, number, and geometry of filter openings 102 may vary depending upon filtering requirements. Material web 100 is surrounded by a peripheral edge 108 that is devoid of filter openings. In accordance with an aspect of the present disclosure, rigid filter plate 74 includes a thickness of between about 80 μm and about 500 μm and each of the plurality of openings has a size of between about 100 μm and about 2 mm.

In accordance with a non-limiting example, peripheral edge 108 includes a first side 118, second side 120 that is opposite of and parallel to the first side 118. Peripheral edge 108 also includes a third side 122 and a fourth side 124. Fourth side 124 is opposite of and parallel to third side 122. Further, third side 122 and fourth side 124 extend between and connect with first side 118 and second side 120 forming a generally quadrilateral shape. It should however be understood that the shape of rigid filter plate may vary and may be dependent upon the shape of the corresponding opening and demands of fluid flow. First side 118 and second side 120 have a first length and are arranged parallel to a first axis A1 that defines a width of rigid filter plate 74. Third side 122 and fourth side 124 have a second length and are arranged parallel to a second axis A2 that defines a length of rigid filter plate 74. In the non-limiting example shown, the first length is less than the second length.

Rigid filter plate 74 includes a first corner 136 defined between first side 118 and third side 122, a second corner 138 defined between first side 118 and fourth side 124, a third corner 140 defined between third side 122 and fourth side 124, and a fourth corner 142 defined between third side 122 and fourth side 124. At this point, it should be understood that while shown as being substantially rectangular, rigid filter plate 74 may possess different shapes. It should also be understood that peripheral edge may include one or more locating or pilot holes 126 that facilitate a selected position of the rigid filter plate 74 relative to opening 70 on spacer plate 64.

In the non-limiting example shown in FIG. 7A, the plurality of filter openings 102 closest to peripheral edge 108 are spaced from peripheral edge 108 by less than a diameter of the plurality of filter openings 102. In FIG. 7B, the plurality of filter openings 102 include a first filter opening density adjacent peripheral edge 108 and a second filter opening density at a central portion 146 of the material web 100. In accordance with an aspect of the present disclosure, the second filter opening density, e.g., space between adjacent filter openings, is distinct from the first opening density. In further accordance with the present disclosure, the second opening density is greater than the first opening density.

In FIG. 7C, rigid filter plate 74 includes a reinforcing member 150 that extends across the width of material web 100 between third side 122 and fourth side 124. Reinforcing member 150 provides additional structural support, e.g., support over and above the support provided by the material forming the filter plate, for material web 100. In FIG. 7D, rigid filter plate 74 includes a reinforcing member 152 that extends across the length of material web 100 between first side 118 and second side 120. In a manner similar to that discussed with respect to reinforcing member 150, reinforcing member 152 provides added structural support for material web 100. Further, in FIG. 7E, a first reinforcing member 160 extends across the width of rigid filter plate 74, a second reinforcing member 162 extends between second corner 138 and third corner 140, and a third reinforcing member 164 extends between first corner 136 and fourth corner 142. First, second, and third reinforcing members provide even more structural support to material web 100. The number, location and arrangement of reinforcing members may vary and can depend on specific flow velocities for different valve bodies.

At this point, it should be understood that the rigid filter plate described herein is more robust than existing filters formed from a wire mesh. Further, the rigid filter plate has an increased bending stiffness and greater fatigue life. Still further, the rigid filter plate can be easily configured to be reinforced at locations determined to have higher velocity flows. Rigid filter plate may also be configured to have filter opening densities that promote greater filtering at particular areas of the material web. While shown as being part of a drive unit for an electric vehicle, the spacer plate, in accordance with the present disclosure may be incorporated into drive units and automatic transmissions for other vehicle types. Still further, while described as being incorporated into a drive unit, the rigid filter plate of the present invention may be incorporated into other vehicle systems that would benefit from filtered fluids.

The terms “substantially” and “about” are intended to include the degree of error associated with measurement of the particular quantity based upon the equipment available at the time of filing the application. For example, “substantially” and “about” can include a range of ±8% of a given value.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is

1. A spacer plate for a drive unit valve body, the spacer plate comprising:
a first layer;
a second layer bonded to the first layer;
a plurality of openings formed in the first layer and the second layer, at least one of the plurality of openings including a rigid filter plate comprising:
a material web including a plurality of filter openings; and
a peripheral edge surrounding the material web, the peripheral edge being devoid of filter openings and arranged between the first layer and the second layer.

2. The spacer plate according to claim 1, wherein the rigid filter plate includes a thickness of between about 80 μm and about 500 μm.

3. The spacer plate according to claim 1, wherein each of the plurality of filter openings is between about 100 μm and about 2.0-mm.

4. The spacer plate according to claim 1, wherein the peripheral edge includes a first side, a second side spaced from the first side, a third side extending between and connecting the first side and the second side, and a fourth side spaced from the third side and extending between and connecting the first side and the second side, the first side and second side having a first length and the third side and the fourth side having a second length that is greater than the first length.

5. The spacer plate according to claim 1, further comprising a reinforcing member extending across the material web.

6. The spacer plate according to claim 1, wherein a first portion of the plurality of filter openings is spaced from the peripheral edge by less than a diameter of the plurality of filter openings.

7. The spacer plate according to claim 1, wherein the plurality of filter openings include a first opening density adjacent the peripheral edge and a second opening density at a central portion of the material web, the second opening density being distinct from the first opening density.

8. The spacer plate according to claim 7, wherein the second opening density is greater than the first opening density.

9. The spacer plate according to claim 1, wherein each of the plurality of openings includes one of a circular shape and a hexagonal shape.

10. The spacer plate according to claim 1, wherein the peripheral edge includes one or more fixturing holes that facilitate alignment of the rigid filter plate relative to the at least one of the plurality of openings in the spacer plate.

11. A drive unit for a vehicle comprising:
a housing;
a valve body fixedly mounted to the housing, the valve body including a plurality of valve plates and a spacer plate arranged between adjacent ones of the plurality of valve plates, the spacer plate comprising:
a first layer;
a second layer bonded to the first layer;
a plurality of openings formed in the first layer and the second layer, at least one of the plurality of openings including a rigid filter plate comprising:
a material web including a plurality of filter openings; and
a peripheral edge surrounding the material web, the peripheral edge being devoid of filter openings and arranged between the first layer and the second layer.

12. The drive unit according to claim 11, wherein the rigid filter plate includes a thickness of between about 80 μm and about 500 μm.

13. The drive unit according to claim 11, wherein each of the plurality of filter openings is between about 100 μm and about 2.0-mm.

14. The drive unit according to claim 11, wherein the peripheral edge includes a first side, a second side spaced from the first side, a third side extending between and connecting the first side and the second side, and a fourth side spaced from the third side and extending between and connecting the first side and the second side, the first side and second side having a first length and the third side and the fourth side having a second length that is greater than the first length.

15. The drive unit according to claim 11, further comprising a reinforcing member extending across the material web.

16. The drive unit according to claim 11, wherein a first portion of the plurality of filter openings is spaced from the peripheral edge by less than a diameter of the plurality of filter openings.

17. The drive unit according to claim 11, wherein the plurality of filter openings include a first opening density adjacent the peripheral edge and a second opening density at a central portion of the material web, the second opening density being distinct from the first opening density.

18. The drive unit according to claim 17, wherein the second opening density is greater than the first opening density.

19. The drive unit according to claim 11, wherein each of the plurality of openings includes one of a circular shape and a hexagonal shape.

20. The drive unit according to claim 11, wherein the peripheral edge includes one or more fixturing holes that facilitate alignment of the rigid filter plate relative at least one of the plurality of openings the spacer plate.
